(19) United States
(12) Patent Application Publication
(10) Pub. No.: US 2024/0392729 A1
(43) Pub. Date: Nov. 28, 2024

(54) SYSTEMS AND METHODS UTILIZING TURBINE COMPRESSOR DISCHARGE FOR HYDROSTATIC MANIFOLD PURGE

(71) Applicant: BJ Energy Solutions, LLC, HOUSTON, TX (US)

(72) Inventors: Tony YEUNG, Tomball, TX (US); Ricardo RODRIGUEZ-RAMON, Tomball, TX (US); Joseph FOSTER, Tomball, TX (US)

(73) Assignee: BJ Energy Solutions, LLC, HOUSTON, TX (US)

(21) Appl. No.: 18/396,438

(22) Filed: Dec. 26, 2023

Related U.S. Application Data
(63) Continuation of application No. 17/132,066, filed on Dec. 23, 2020, now Pat. No. 11,898,504.
Application No. 17/132,066 is a division of application No. 15/929,770, filed on May 21, 2020, now Pat. No. 10,968,837.
(60) Provisional application No. 62/704,539, filed on May 14, 2020.

(51) Int. Cl. F02C 9/40; E21B 43/26; F02C 7/22; F02C 7/232

(52) U.S. Cl. CPC F02C 9/40; E21B 43/2607; F02C 7/222; F02C 7/232; F05D 2210/11; F05D 2210/12; F05D 2220/32; F05D 2240/35; F05D 2240/40; F05D 2260/60

(57) ABSTRACT

Embodiments of systems and methods for air recovery are disclosed. The diverted pressurized air may be used to supply a hydrostatic purge to the unutilized portion of a turbine engine fuel manifold circuit to ensure that exhaust gases from the utilized side of the fuel manifold circuit do not enter the portion of the alternative fuel manifold circuit rack. The assembly used to remove compressor section pressurized air may include a flow control orifice, line pressure measuring instrumentation, non-return valves, isolation valves and hard stainless-steel tubing assemblies. In some embodiments, a turbine compressor section diverter system may include a small air receiver used to increase the volume of air supplying the manifold to aid in potential pressure and flow disruptions from a turbine engine compressor section.

### CROSS REFERENCE TO RELATED APPLICATION

This application is a continuation of U.S. Non-Provisional application Ser. No. 17/132,066, filed Dec. 23, 2020, which is a divisional of U.S. Non-Provisional application Ser. No. 15/929,770, filed May 21, 2020, which claims priority to and the benefit of U.S. Provisional Application No. 62/704,539, filed May 14, 2020, titled “AIR RECOVERY SYSTEMS AND METHODS TO UTILIZE TURBINE COMPRESSOR DISCHARGE PRESSURE”, the entire disclosures of each of which are incorporated herein by reference.

### TECHNICAL FIELD

The application relates generally to that of turbine engines having dual fuel manifold circuits and associated methods. More specifically, this application relates to dual fuel, dual shaft turbine engines for the high pressure pumping and hydraulic fracturing market, as well as power generation, manufacturing, healthcare, and agricultural machinery markets.

### BACKGROUND

Traditionally turbine engines operate from a single fuel source; that fuel source being what is known as #2 diesel or gaseous fuels such as natural gas. The turbine industry recently has developed turbines that may accept dual fuels to combat redundancy and dependency of a single fuel source to be able to operate and allow for all relating operations to be carried out uninterrupted. In most dual fuel turbine engines, the ability to perform fuel switching is carried out by the need to shut down the engine and replace the fuel manifold with one designed for the desired fuel source. An example of this is the time consuming removal of a gaseous fuel manifold pipework and components and the re-installation of a liquid fuel manifold; this is an occurrence in some turbine engines supplied by manufacturers such as General Electric (GE) or Siemens. The issues involved with a turbine fuel manifold replacement include time consumption, the need for highly skilled personnel, specialized tooling, and the potential of disruption to other components in the turbine when performing the switch.

The detrimental factors involved with these fuel switching procedures has caused many turbine engine manufactures to develop turbine engines that may house a single distribution manifold and be supplied from two fuel sources; one being liquid fuel and the other being gaseous fuel respectively. This removed many of the problems associated with fuel switching on turbine engines and even allowed for fuel switching to be performed “on the fly”. One condition that is still required to operate and perform such functions is the supply of a hydrostatic purge to the unused side of the turbine fuel manifold, thereby stopping exhaust gases from the “fuel in use” to enter the dormant fuel manifold and preventing damage and dirt ingress to components and pipework. The conventional way in which this hydrostatic purge is being performed is from an externally mounted air compressor that directs the generated air flow through a pneumatic intensifier system to increase the air pressure to that of the pressure of the exhaust gases and is then injected though a diverter valve that directs the flow to the fuel manifold that is in need of the purge.

### SUMMARY

Applicant has recognized that despite this conventional hydrostatic purge being an effective and proven way to perform such an operation, the need for additional components and circuitry results in additional power consumption, additional space requirements, more machine consumables, and staged instrumentation to ensure that each sector of the system is producing the correct amount of pressure and flow to be able to meet the requirements of the fuel manifold.

Accordingly, Applicant discloses herein embodiments of systems, apparatuses, and methods to utilize turbine engine compressed air from a multi-stage compressor section of a turbine and direct the compressed air to the fuel manifold in an effort to reduce the dependency on external machinery and make the turbine fuel system more self-sustaining, for example. In one embodiment, for example, a system for the removal of compressed gas from a turbine compressor section is disclosed and includes an orifice fitting, a non-return valve, pressure reading instrumentation, actuated directional control valves and stainless-steel tubing to distribute the compressed air. The removal of compressed gas comes from a pre-drilled and tapped entry hole into the last compressor section that is positioned and sized so as not to disrupt regular turbine operation.

In another embodiment of a compressed air removal system, a system may include a variably flow control valve that is fed compressed air from the turbine section and adjusted to meet the demand of the fuel manifold while working in conjunction with previous components detailed above, for example.

In still another embodiment, a fuel manifold is disclosed to allow for receiving of compressor section air and allowing for the amount of compressed gas needed to be reduced resulting in less air flow removed from the compressor section. This, for example, allows more mass air flow to be delivered to the combustion chamber of the dual fuel dual shaft turbine engine.

In a further embodiment, a method for the storage of compressed air from the turbine compressor section is disclosed. This storage of compressed air may allow for onboard storage of high pressure compressed air on a hydraulic fracturing oilfield trailer and may be used to compensate for the pressure and flow variations of air supplied from the turbine during times of turbine start up, idle, and power disruption as will be understood by one skilled in the art.

In another embodiment, a dual fuel gas turbine engine includes a primary compressor, a combustion chamber, and a manifold pressurization system. The primary compressor has an inlet opening and an outlet opening. The combustion chamber is in fluid communication with the outlet opening of the primary compressor and is positioned to receive compressed air from the outlet opening of the primary compressor. The combustion chamber includes a first fuel manifold circuit and a second fuel manifold circuit. The combustion chamber has a first mode of operation in which the first fuel manifold circuit is configured to provide fuel to the combustion chamber and the second fuel manifold circuit is unused. The combustion chamber may have a second mode of operating in which the second fuel manifold circuit is configured to prevent fuel to the combustion chamber and the first fuel manifold circuit is unused. The manifold pressurization system includes a purge inlet, a common purge line, a first purge line, a second purge line, and a control valve. The purge inlet is in fluid communication with the primary compressor adjacent the outlet opening. The common purge line is connected at an upstream end to the purge inlet. The common purge line is configured to provide purge air at a purge pressure equal to or greater than a combustion pressure within the combustion chamber. The first purge line is connected at a downstream end thereof to the first fuel manifold circuit. The second purge line is connected at a downstream end thereof to the second fuel manifold circuit. The control valve is connected to a downstream end of the common purge line, an upstream end of the first purge line, and an upstream end of the second purge line. The control valve has a first position in which the control valve connects the common purge line with the second purge line to supply purge air to the second fuel manifold circuit. The control valve has a second position in which the control valve connects the common purge line with the first purge line to supply purge air to the first fuel manifold circuit. The control valve is in the first position when the combustion chamber is in the first mode of operation and in the second position when the combustion chamber is in the second mode of operation.

In some embodiments, the common purge line includes an orifice that is configured to limit a volume of air removed from the primary compressor. The orifice may be a fixed orifice and, in some embodiments, may be replaceably received within an orifice fitting such that a size of the fixed orifice is variable.

In certain embodiments, the primary compressor is a multistage compressor having a P3 point and the purge inlet may be positioned at the P3 point of the primary compressor.

In particular embodiments, the common purge line includes a plenum that is configured to store purge air. The common purge line may include a pneumatic intensifier that is configured to increase a pressure of purge air within the common purge line to the purge pressure.

In a further embodiment, a hydraulic fracturing pumping system includes an engine as detailed herein, a hydraulic fracturing pump, and a trailer. The hydraulic fracturing pump is connected to the engine such that the hydraulic fracturing pump I driven by the engine. The engine and the hydraulic fracturing pump may be mounted to the trailer.

In another embedment, a manifold pressurization system includes a purge inlet, a common purge line, a first purge line, a second purge line, and a control valve. The purge inlet is configured to receive purge air from a compressor of an engine. The common purge line is connected at an upstream end to the purge inlet. The common purge line is configured to provide purge air at a purge pressure. The first purge line is configured to connect at a downstream end thereof to a first fuel manifold circuit of the engine. The second purge line is configured to connect at a downstream end thereof to a second fuel manifold circuit of the engine. The control valve is connected to a downstream end of the common purge line, an upstream end of the first purge line, and an upstream end of the second purge line. The control valve has a first position in which the control valve connects the common purge line with the second purge line. The control valve has a second position in which the control valve connects the common purge line with the first purge line. The control valve is configured to selectively provide purge air to the first fuel manifold circuit or the second fuel manifold circuit to prevent backflow of air into the respective one of the first fuel manifold circuit or the second fuel manifold circuit.

In a further embodiment, a method of operating a duel fuel engine includes supplying a first fuel to a combustion chamber of an engine in a first mode of operation and switching the engine to a second mode of operation such that a second fuel is supplied to the combustion chamber, supplying combustion air to the combustion chamber with a primary compressor of the engine, diverting purge air from the primary compressor, positioning a direction control valve in a first position, and positioning the directional control valve in a second position. In the first mode of operation of the engine the first fuel may be supplied to the combustion chamber through a first fuel manifold circuit and no fuel may be supplied to the combustion chamber through a second fuel manifold circuit. Switching the engine to the second mode of operation may include the second fuel being supplied to the combustion chamber through the second fuel manifold circuit and no fuel being supplied to the combustion chamber through the first fuel manifold circuit. Diverting purge air from the primary compressor may include diverting air into a common purge line from the primary compressor via a purge inlet during operation of the engine. The purge air by be separated from the combustion air before the combustion chamber. Positioning the control valve in the first position may include positioning the control valve in the first position in the first mode of operation such that the diverted purge air flows into the second fuel manifold circuit at a purge pressure that is equal to or greater than a pressure within the combustion chamber such that backflow from the combustion chamber into the second fuel manifold circuit is prevented. Positioning the directional control valve in the second position may include positioning the control valve when the engine is in the second mode of operation such that the diverted purge air flows into the first fuel manifold circuit a purge pressure equal to or greater than a pressure within the combustion chamber such that backflow from the combustion chamber into the first fuel manifold circuit is prevented.

In embodiments, the method may include selecting a fixed orifice based on a pressure of the primary compressor and fitting the selected fixed orifice in the common purge line to limit a volume of air diverted from the primary compressor.

### BRIEF DESCRIPTION OF THE DRAWINGS

The accompanying drawings, which are included to provide a further understanding of the embodiments of the present disclosure, are incorporated in and constitute a part of this specification, and together with the detailed description, serve to explain the principles of the embodiments discussed herein. The present disclosure may be more readily described with reference to the accompanying drawings.

FIG. 1 is a perspective view of a mobile power unit according to embodiments of the disclosure.

FIG. 2 is a perspective view of a turbine engine being used to drive a fracturing pump according to embodiments of the disclosure.

FIG. 3 is a schematic diagram which highlights the turbine compressor sections of a dual shaft turbine engine according to embodiments of the disclosure.

FIG. 4 is a 2-axis Pressure (P) versus volume (v) graph and diagram demonstrating the Brayton Cycle for a Turbine Engine according to embodiments of the disclosure.

FIG. 5 is a schematic diagram that illustrates pipework and components of a dual fuel turbine engine according to embodiments of the disclosure.

FIG. 6 is a schematic diagram that illustrates an example of a fuel purge and air recovery system according to embodiments of the disclosure.

FIG. 7 is a 2-axis graph of air volume versus air pressure which shows the allowable air flow through an orifice given pressure and orifice size according to embodiments of the disclosure.

FIG. 8 is a schematic diagram a fuel purge and air recovery system with the inclusion of a pneumatic intensifier according to embodiments of the disclosure.

FIG. 9 is a flowchart illustrating a method of operating an engine according to embodiments of the present disclosure.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect may be combined with features from any other embodiment or aspect in any appropriate combination. For example, any individual or collective features of method aspects or embodiments may be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

The embodiments of the present disclosure are directed to mobile power units, for example, mobile power units that are mounted to a transportation platform that are transportable on and off highways. In particular, embodiments of the present disclosure are directed to manifold pressurization systems that are mounted to a transportation platform with a mobile power unit. The manifold pressurization systems disclosed herein utilize air from a compressor of the engine to purge an unused manifold circuit of the engine. In some embodiments, for example, the manifold pressurization systems may hydrostatically purge the unused manifold circuits of the engine.

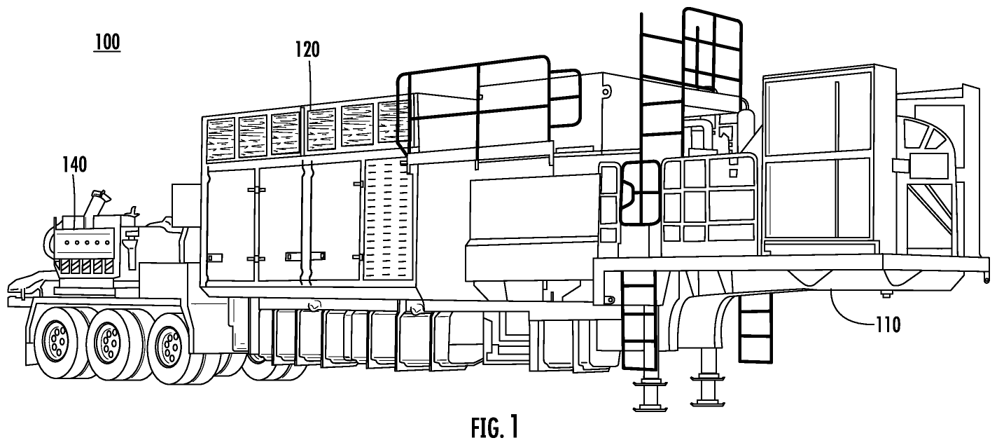

FIG. 1 illustrates an exemplary mobile power unit 100 is provided in accordance with an embodiment of the present disclosure. The exemplary mobile power unit 100 includes transportation platform 110, an engine 120, and a power unit 140. The transportation platform 110 is shown as a single trailer with the entire mobile power unit 100 and components thereof mounted thereto. For example, it may be advantageous to have the entire mobile power unit 100 mounted to a single trailer such that setup and startup of the mobile power unit 100 does not require onsite assembly of the mobile power unit 100. In addition, mounting the entire mobile power unit 100 to a single trailer may decrease a footprint of the mobile power unit 100. The transportation platform 110 may be a trailer that may be pulled by a tractor (not shown) on and off public highways. In some embodiments, the transportation platform may include more than one trailer.

The engine 120 is mounted to the transportation platform 110 and may be any suitable engine including, but not limited to, an internal combustion engine or a gas turbine engine. The engine 120 may be a dual fuel engine operating on gasoline, natural gas, well gas, field gas, diesel, and/or other suitable fuel. In some embodiments, the engine 120 may be a dual fuel engine operating on a liquid fuel and a gaseous fuel. In certain embodiments, the engine 120 is a dual fuel gas turbine engine that asynchronously operates on diesel fuel, e.g., #2 diesel as will be understood by those skilled in the art, and on a gaseous fuel, e.g., natural gas, well gas, or field gas. In particular embodiments, the engine 120 is a dual fuel, dual shaft gas turbine engine that operates on a liquid fuel such as diesel fuel and a gaseous fuel such as natural, well gas, or field gas.

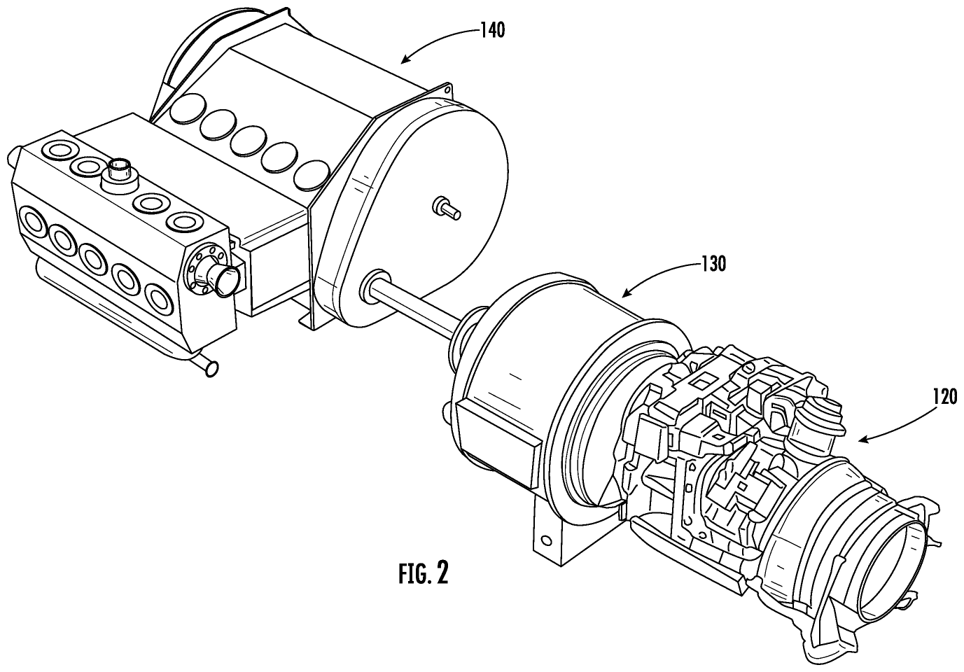

FIG. 2 illustrates an exemplary engine 120 and power unit 140 configuration provided in accordance with an embodiment of the present disclosure. The engine 120 is operably coupled to the power unit 140 such that the engine 120 drives the power unit 140 to supply power to a system external of the mobile power unit 100. As shown, the power unit 140 is a high pressure pump, such as those that include hydraulic fracturing pumps, that is configured to supply power in the form of high pressure fluid. The power unit 140 may be a high pressure single acting reciprocating pump or a high pressure centrifugal pump. In certain embodiments, the power unit 140 may be a generator configured to produce electric power. The engine 120 may be operably coupled to the power unit 140 by a gearbox 130. The gearbox 130 may decrease a speed of an input from the engine 120 while increasing a torque or increase the speed of an input from the engine 120 while decreasing a torque. In some embodiments, the gearbox 130 is a transmission that allows for adjustment of the ratio between a speed of rotation of the input from the engine 120 to a speed of rotation of the power unit 140. In certain embodiments, the transmission has a set number of speed ratios. In particular embodiments, the transmission is continuously variable through a wide range of speed ratios. Other variations of pump, drive shaft, gearbox, and turbine may be used with the achieved goal of high volume, high pressure fluid delivery being achieved as will be understood by those skilled in the art. As will be appreciated, turbine engines are a type of high RPM (rotations per minute) prime mover which are optimized to produce high shaft horse power (SHP) in relevance to their compact size.

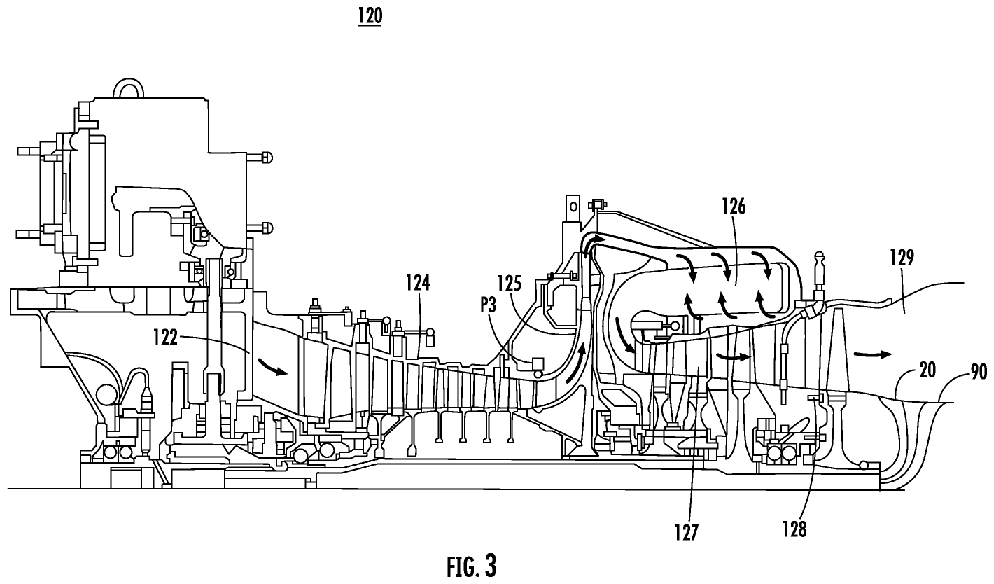

FIG. 3 illustrates a schematic of an exemplary engine 120 shown as a dual-shaft gas turbine engine. The engine 120 includes an intake 122, an axial compressor 124, a radial compressor 125, a combustion chamber 126, a producer turbine 127, a power turbine 128, and an exhaust duct 129 as will be understood by those skilled in the art. As air moves through the compressors 124, 125 from the intake 122 to the combustion chamber 126, the pressure of the air is increased. As the air moves through the combustion chamber 126, fuel is mixed with the air and ignited such that the temperature of the air is increased. As the air flows through the producer and power turbines 127, 128 the pressure of the air is decreased as the air rotates the turbines 127, 128. The air continues through engine 120 and out the exhaust duct 129 to be released to the environment.

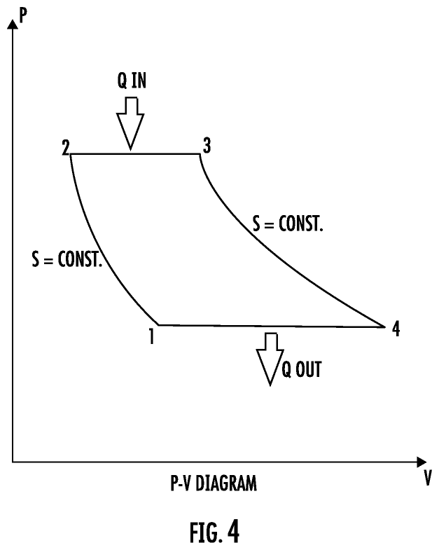

FIG. 4, for example, demonstrates the Brayton cycle for a turbine engine for which the prime working media of a turbine is air and the conditions in which air enters the compressor section of the turbine engine directly correlates to the amount of SHP a turbine engine, e.g., engine 120, may produce. At point 1, air is drawn into the turbine inlet or intake. At point 2 the air has been compressed resulting in a pressure increase and a reduction in volume. From point 2 to point 3 the air is passed into the combustion chamber 126. As the air is passed from point 2 to point 3, the turbine extracts power from the hot high pressure air that is generated from the air and fuel combustion mixture resulting in a drop in pressure but a drastic increase in volume. This combusted or exhaust air is then exhausted out of the turbine from point 4 to 1 where the cycle repeats itself for the duration of the operation of the turbine.

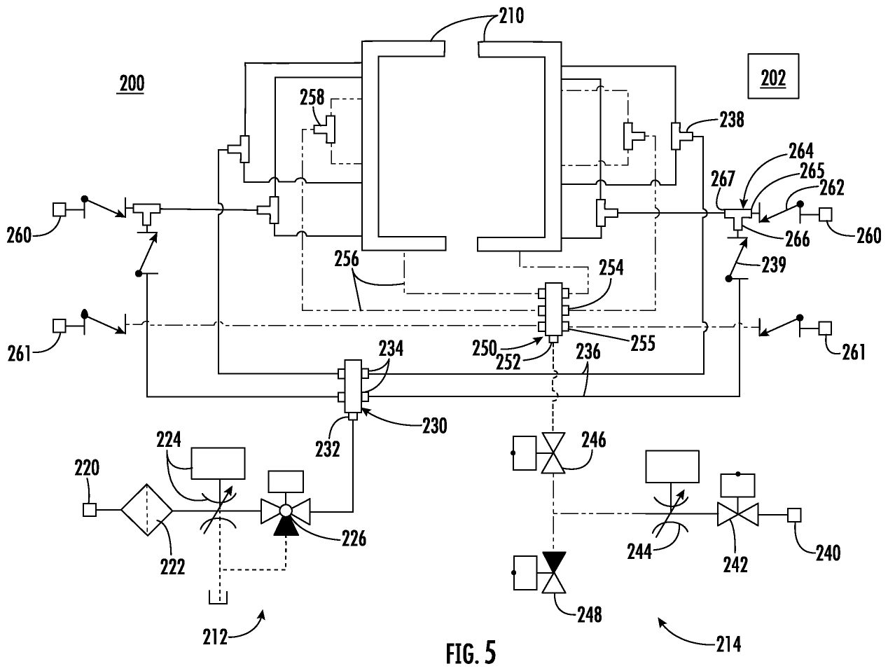

FIG. 5 illustrates an exemplary dual fuel delivery circuits 200 provided in accordance with the present disclosure. The dual fuel delivery circuits 200 is configured to selectively provide a liquid fuel or a gaseous fuel to a combustion chamber of an engine, e.g., engine 120. The dual fuel delivery circuits 200 includes inputs of a liquid fuel, a gaseous fuel, and purge air and outputs substantially all of the inputs through the fuel distribution manifolds 210 as detailed below. It will be appreciated by one skilled in the art that a portion of the liquid fuel and the gaseous fuel may be returned to a fuel reservoir or the environment as detailed below.

Starting with the first or liquid fuel manifold circuit 212 of the fuel delivery circuits 200, the liquid fuel manifold circuit 212 includes a liquid fuel inlet 220 that receives liquid fuel from a liquid fuel reservoir (not explicitly shown). The liquid fuel reservoir may include a fuel pump (not shown) that pressurizes the liquid fuel for use within the liquid fuel manifold circuit 212. From the liquid fuel inlet 220, the liquid fuel flows through a fuel filter 222, a liquid fuel metering valve 224, and a liquid fuel control valve 226. At the liquid fuel metering valve 224 and the liquid fuel control valve 226, excess liquid fuel may be directed out of the fuel delivery circuits 200 and returned to the liquid fuel reservoir. The liquid fuel control valve 226 has a supply or first position in which the liquid fuel control valve 226 supplies liquid fuel from the liquid fuel metering valve 224 to a liquid fuel distribution block 230 and a divert or second position in which the liquid fuel control valve 226 directs fuel from the liquid fuel metering valve 224 back to the fuel reservoir. The liquid fuel control valve 226 may include solenoid that switches the liquid fuel control valve 226 between the first and second positions thereof. For example, the solenoid may have an off or deactivated condition corresponding to the second position of the liquid fuel control valve 226 and an on or activated condition corresponding to the first position of the liquid fuel control valve 226. The solenoid may be adjustable between the activated and deactivated condition such that the liquid fuel control valve 226 is between the supply and divert positions thereof. The liquid fuel metering valve 224 may be electrically controlled to control a flow, e.g., an amount, of liquid fuel into the fuel delivery circuits 200.

The liquid fuel distribution block 230 receives liquid fuel through a block inlet 232 and distributes the liquid fuel through two or more block outlets 234. Each of the block outlets 234 is in fluid communication with a fuel manifold 210 by the way of one or more liquid fuel lines 236. The individual liquid fuel lines 236 may extend from the liquid fuel distribution block 230 directly to one of the fuel manifolds 210 or may pass through one or more additional components of the fuel delivery circuits 200. As shown, one of the liquid fuel lines 236 may pass through a tee 238 such that the liquid fuel line 236 is divided from one liquid fuel line 236 into two liquid fuel lines 236 that extend from the tee 238 to the fuel manifold 210. A tee 238 may divide a single liquid fuel line 236 into two or more liquid fuel lines 236. Additionally, or alternatively, a liquid fuel line 236 may pass through a check valve 239 and then into a tee 264 before continuing towards the fuel manifold 210. The check valve 239 allows for flow through the liquid fuel line 238 downstream, e.g., towards the fuel manifold 210, and prevents backflow within the liquid fuel line 238, e.g., towards the distribution block 230. The tee 264 will be detailed below with respect to the purge air portion of the fuel delivery circuits 200.

Continuing to refer to FIG. 5, the second or gaseous fuel manifold circuit 214 of the fuel delivery circuits 200 is detailed in accordance with an embodiment of the present disclosure. The gaseous fuel manifold circuit 214 includes a gaseous fuel inlet 240 that receives gaseous fuel from a gaseous fuel source (not explicitly shown). The gaseous fuel source may be a pipeline, a well, or a storage tank, as understood by one skilled in the art. The gaseous fuel source may be pressurized or may include a gaseous fuel pump or intensifier to pressurize the gaseous fuel. From the gaseous fuel inlet 240, the gaseous fuel flows through a primary gaseous fuel valve 242, a gaseous fuel metering valve 244, a secondary gaseous fuel control valve 246, and a bleed valve 248. The primary gaseous fuel control valve 242 has a supply or first position in which the primary gaseous fuel control valve 242 supplies gaseous fuel to the gaseous fuel metering valve 244 and a closed or second position in which the primary gaseous fuel control valve 242 prevents gaseous fuel from entering the fuel delivery circuits 200. The gaseous fuel metering valve 244 may be electrically controlled to control a flow, e.g., an amount, of gaseous fuel into the fuel delivery circuits 200. The primary gaseous fuel control valve 242 may include a solenoid that transitions the primary gaseous fuel control valve 242 between the first and second positions thereof. The deactivated condition of the solenoid may correspond to the closed position of the primary gaseous fuel control valve 242.

The secondary gaseous control valve 246 is downstream of the gaseous fuel metering valve 244. The secondary gaseous control valve 246 has a supply or first position in which the secondary gaseous control valve 246 supplies gaseous fuel to a gaseous fuel hub 250 and a closed or second position in which the secondary gaseous control valve 246 prevents gaseous fuel from entering the gaseous fuel hub 250. The secondary gaseous control valve 246 may include a solenoid that transitions the secondary gaseous control valve 246 between the first and second positions thereof. The deactivated condition of the solenoid may correspond to the closed position of the secondary gaseous control valve 246.

The bleed valve 248 is downstream of the gaseous fuel metering valve 244 and upstream of the secondary gaseous control valve 246 but is out of a direct flow path between the gaseous fuel metering valve 244 and the secondary gaseous control valve 246. The bleed valve 248 has a bleed or first position in which the bleed valve 248 diverts gaseous fuel from the secondary gaseous control valve 246 and a closed or second position in which the secondary gaseous control valve 246 prevents gaseous fuel from exiting the fuel delivery circuits 200. The bleed valve 248 may include a solenoid that transitions the bleed valve 248 between the first and second positions thereof. The deactivated condition of the solenoid may correspond to the closed position of the bleed valve 248. Diverting the gaseous fuel from the secondary gaseous control valve 246 may include returning the gaseous fuel to the supply of gaseous fuel, releasing the gaseous fuel to the environment, diverting the gaseous fuel to a storage tank, or delivering the gaseous fuel to a distribution network, e.g., a pipeline, as will be understood by one skilled in the art.

The gaseous fuel distribution block 250 receives gaseous fuel through a block inlet 252 and distributes the gaseous fuel through two or more block outlets 254. The gaseous fuel distribution block 250 also includes a purge inlet 255 that is in fluid communication with a purge inlet 260 as detailed below with respect to the purge air side of the fuel delivery circuits 200. Each of the block outlets 254 is in fluid communication with a fuel manifold 210 by the way of one or more gaseous fuel lines 256. The individual gaseous fuel lines 256 may extend from the gaseous fuel distribution block 250 directly to one of the fuel manifolds 210 or may pass through one or more additional components of the fuel delivery circuits 200. As shown, one of the gaseous fuel lines 256 may pass through a tee 258 such that the gaseous fuel line 256 is divided from one gaseous fuel line 256 into two gaseous fuel lines 256 that extend from the tee 258 to the fuel manifold 210. A tee 258 may divide a single gaseous fuel line 256 into two or more gaseous fuel lines 256.

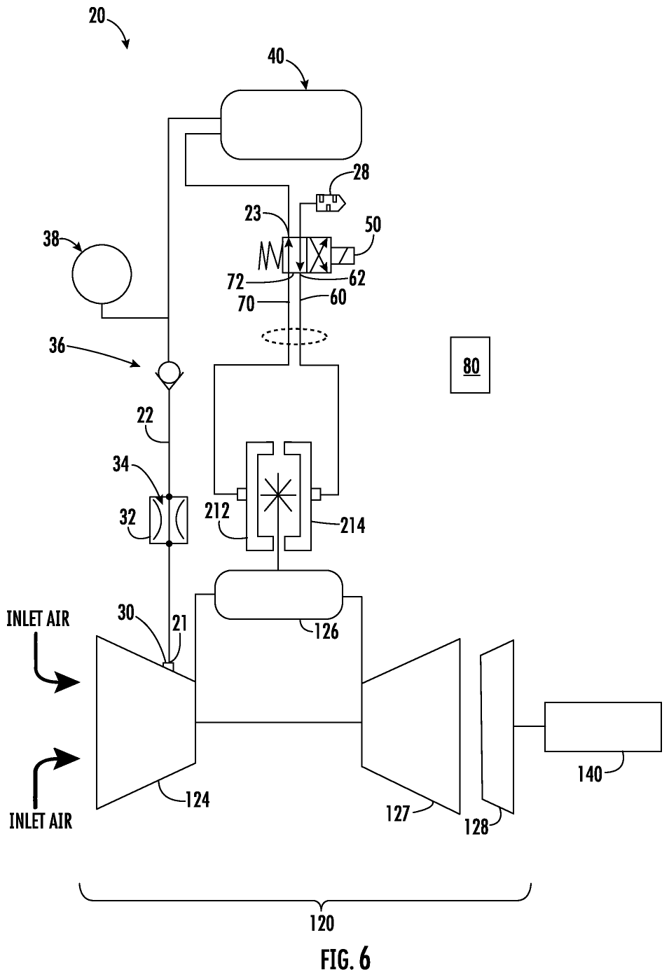

Still referring to FIG. 5, the fuel delivery circuits 200 receives purge air as detailed in accordance with an embodiment of the present disclosure. The liquid side purge inlet 260 is in fluid communication with a first purge line 60 (FIG. 6) and the gas side purge inlet 261 is in fluid communication with a second purge line 70 (FIG. 6), which are described in detail below.

The liquid fuel manifold circuit 212 includes a check valve 262 downstream of each of the liquid side purge inlet 260. The check valve 262 allows flow of purge air downstream, e.g., towards the fuel manifolds 210, and prevents flow upstream. The liquid side purge inlet 260 is in fluid communication with a tee air inlet 265 of the tee 264. The tee 264 also includes a tee liquid inlet 266 that is in fluid communication with the liquid fuel block 230 such that liquid fuel is supplied to the tee 264. The tee 264 further includes a tee outlet 267 that flows downstream to the fluid manifold 210 such that purge air and/or liquid fuel from the tee 264 flows into the fuel manifold 210. When the liquid side purge inlet 260 receives purge air, the purge air flows through the tee 264 such that liquid fuel downstream of the tee 264 flows into the fuel manifold 210 and the fuel manifold 210 is filled with purge air such that exhaust gases from the combustion chamber 126 and gaseous fuel from the fuel manifolds 210 are prevented from flowing upstream into the liquid fuel manifold circuit 212 of the fuel delivery circuits 200 when liquid fuel is not being supplied to the fuel manifolds 210.

The gaseous fuel manifold circuit 214 includes a check valve 262 downstream of each of the gaseous side purge inlet 261. The check valve 262 allows flow of purge air downstream, e.g., towards the fuel manifolds 210, and prevents flow upstream. The gas side purge inlet 261 is in fluid communication with the gaseous fuel distribution block 250 such that purge air flows downstream from the gas side purge inlet 261 into the gaseous fuel distribution block 250 via the purge inlet 255. When the gas side purge inlet 261 receives purge air, the purge air flows into the gaseous fuel distribution block 250 such that gaseous fuel downstream of the gaseous fuel distribution block 250 flows into the fuel manifold 210 from the gaseous fuel manifold circuit 214 of the fuel delivery circuits 200 is filled with purge air such that exhaust gases from the combustion chamber 126 and liquid fuel within the fuel manifolds 210 are prevented from flowing upstream into the gaseous fuel manifold circuit 214 of the fuel delivery circuits 200 when gaseous fuel is not being supplied to the fuel manifold 210.

The components of the fuel delivery circuits 200, e.g., valves 224, 226, 242, 244, 246, and 248, may be controlled by a controller 202. The controller 202 may be part of an engine controller of the engine 120 or may be a separate subcontroller of the fuel delivery circuits 200. The controller 202 may receive and provide signals to one or more other controllers as will be appreciated by one skilled in the art.

As detailed above, in some prior art purge air systems, the purge air is provided to the liquid side purge inlet 260 and the gaseous side purge inlet 261 from a pneumatic intensifier apparatus which takes in air at atmospheric pressure and increases the pressure to a purge pressure that is greater than a pressure of the exhaust gases within the combustion chamber 126. Such a pneumatic intensifier apparatus takes up significant space and requires additional power inputs to power the pneumatic intensifier apparatus. The manifold pressurization systems detailed below in accordance with an embodiments of the present disclosure receive air at a pressure significantly higher than atmospheric pressure and in some instances at or above the purge pressure such space and/or power requirements required for a pneumatic intensifier apparatus is reduced or eliminated from mobile power unit 10 (FIG. 1). This space savings may allow for a reduced size of the mobile power unit 10 or for additional components of the mobile power unit 10 to be mounted to a single transportation platform 110.

FIG. 6 illustrates a manifold circuit pressurization system 20 provided in accordance with embodiments of the present disclosure which is mounted to an engine, e.g., engine 120. The manifold circuit pressurization system 20 includes a common purge line 22, a first purge line 60, and a second purge line 70. The common purge line 22 has an upstream end 21 and a downstream end 23 and includes, from the upstream end 21 to the downstream end 23, a purge inlet 30, and a control valve 50. The common purge line 22 receives compressed air from a compressor of the engine 120 through the purge inlet 30. As shown, the purge inlet 30 is positioned adjacent an outlet of the primary compressor 124, e.g., at the last compressor section of the primary compressor 124. In embodiments, the purge inlet 30 is positioned at a P3 take off point of the primary compressor 124. In certain embodiments, the purge inlet 30 uses an existing P3 take off designed for a pressure transducer of the primary compressor 124 as the purge inlet 30 for the manifold circuit pressurization system 20. It will be appreciated by one skilled in the art that the P3 take off of a compressor is a point where the pressure of the air within the compressor is at its highest and the volume of the air is at its smallest within the compressor, e.g., point 2 of the Brayton Cycle of FIG. 4. As the pressure of the purge air entering the manifold circuit pressurization system 20 is already at a pressure substantially equal to the highest pressure within the engine 120, including the pressure within the combustion chamber 126, the manifold circuit pressurization system 20 may be provided without a pneumatic intensifier. The purge air inlet 30 is sized to not disrupt regular turbine operation.

The purge inlet 30 may include a valve that has an open position in which the purge inlet 30 allows for air to flow into the common air line 22 and closed position in which the air is prevented from flowing into the common air line 22. The valve of the purge inlet 30 may be a variable valve that is in electrical or wireless communication with a controller 80. The controller 80 may receive a signal from a pressure sensor 38 associated with the common purge line downstream of the purge inlet 30. The controller 80 may control a position of the valve of the purge inlet 30 in response to a pressure within the common purge line 22. The controller 80 may have a predetermined purge pressure programed therein that is a desired pressure of purge air within the common purge line 22. Additionally or alternatively, the controller 80 may receive a pressure within the combustion chamber 126 from a sensor within the combustion chamber 126 and/or a controller of the engine 120. The controller 80 may control the valve of the purge inlet 30 in response to a pressure within the combustion chamber 126. The controllers detailed herein, e.g., controllers 80, 202, may be commonly programmable logistical controllers (PLC), micro controllers, and/or off highway controllers.

The common purge line 22 may include an orifice 34 downstream of the purge inlet 30 that limits a volume of air drawn from the compressor 124 such that the air diverted to the common purge line 22 does not have a detrimental effect on the overall efficiency of the primary compressor 124 and thus the engine 120. The orifice 34 may be a variable orifice or valve that is configured to control an amount of air drawn into the common purge line 22 from the primary compressor 124. The orifice 34 may be controlled by the controller 80 in response to a pressure within the common purge line 22 downstream of the orifice 34 and/or a pressure within the combustion chamber 126 in a manner similar to control of the valve of the purge inlet 30 detailed above.

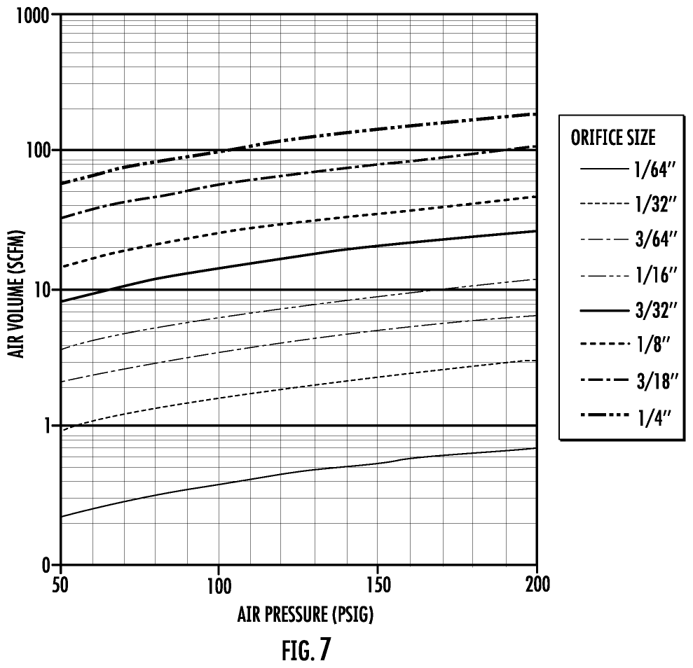

In some embodiments, the orifice 34 may be a fixed orifice that limits a volume of air drawn from the primary compressor 124 such that the air diverted to the common purge line 22 does not have a detrimental effect on the overall efficiency of the compressor 124 and thus the engine 120. FIG. 7 illustrates a volume of air that passes through a fixed orifice having a variety of sizes base on an air pressure within the common purge line 22. As shown in FIG. 7, the fixed orifice 34 may be sized, e.g., an opening of the fixed orifice, in a range of 1/64 of an inch to ¼ of an inch. The orifice 34 may be fixed within the common purge line 22 based on properties of the compressor 124 and/or engine 120. In some embodiments, the common purge line 22 may include an orifice fitting 32 that removably receives the fixed orifice 34. The orifice fitting 32 may allow for the fixed orifice 34 to be varied or replaced based on operating parameters of the compressor 124 and or engine 120. For example, if the compressor 124 is operating below an optimum pressure, the size of the fixed orifice 34 may be increased to allow more air into the common purge air line 22 or may be decreased to allow less air into the common purge air line 22.

The manifold pressurization system 20 may include the valve of the purge inlet 30, the orifice 34 (variable or fixed), or both the valve of the purge inlet 30 and the orifice 34 (variable or fixed). The pressure sensor 38 is positioned within the common purge line 22 downstream of purge inlet 30 and/or the orifice 34. The pressure sensor 38 may measure a pressure within the common purge line 22 and may transmit a signal indicative of the pressure within the common purge line 22 to one or more controllers associated with the engine 120, e.g., controller 80 or controller 202 (FIG. 4).

The common purge line 22 may include a check valve 36 between purge inlet 30 and the control valve 50. When the common purge line 22 includes an orifice 34, the check valve 36 may be downstream of the orifice 34. The check valve 36 allows air within the common purge line 22, e.g., purge air, to flow downstream towards the control valve 50 and prevents air within the common purge line 22 from backflowing upstream towards and into the compressor 124.

The common purge line 22 may include a purge air reservoir 40 downstream of the check valve 36. The purge air reservoir 40 may store purge air at purge pressure upstream of the control valve 50. The purge air reservoir 40 may stabilize a pressure within the common purge line 22 due to fluctuations of pressure from the compressor 124. For example, the purge air reservoir 40 may compensate for pressure and flow variations of air supplied from the primary compressor 124 during start up, idle, and/or power disruption. Additionally, or alternatively, the purge air reservoir 40 may provide purge air to the control valve 60 when the purge inlet 30 is in a closed position. The purge air reservoir 40 may provide purge air to the control valve 50 when the compressor 124 is not operating. For example, the purge air reservoir 40 may provide purge air to the control valve 50 to purge the fuel manifold circuits 200 when the primary compressor 124 is not operating.

Continuing to refer to FIG. 6, the control valve 50 is in fluid communication with a downstream end 23 of the common purge line 22, an upstream end 62 of the first purge line 60, and an upstream end 72 of the second purge line 70. Downstream flow within the common valve 50 is from the common purge line 22 into the first or second purge line 60, 70. The control valve 50 has a first position in which the control valve 50 connects the common purge line 22 with the first purge line 60 such that the common purge line 22 is in fluid communication with the gaseous or second fuel manifold circuit 214. In the first position of the control valve 50, the control valve 50 may connect the upstream end 62 of the second purge line 60 to a pressure relief valve 28. The control valve 50 also has a second position in which the control valve 50 connects the common purge line 22 with the second purge line 70 such that the common purge line 22 is in fluid communication with the liquid or first fuel manifold circuit 212. In the second position of the control valve 50, the control valve 50 may connect the upstream end 72 of the second purge line 70 to the pressure relief valve 28. The control valve 50 may have a third position in which the common purge line 22 is not in fluid communication with either of the first purge line 60 or the second purge line 70. In the third position, the first and/or the second purge line 60, 70 may be in fluid communication with the pressure relief valve 28. The pressure relief valve 28 may remain in a closed position to prevent air in fluid communication therewith from escaping the manifold pressurization system 20 and may have an open position in which the pressure relief valve 28 releases pressure in fluid communication therewith to the environment. The pressure relief valve 28 may release pressure to prevent excess pressure within the fluid manifold circuits 212, 214.

The position of the control valve 50 is controlled by the controller 80. Specifically, when the engine 120 is in a first mode of operation in which it receives fuel from the first manifold circuit 212, the controller 80 positions the control valve 50 in the first position such that purge air is provided to the second manifold circuit 214. When the engine 120 is in the second mode of operation in which it receives fuel from the second manifold circuit 214, the controller 80 positions the control valve 50 in the second position such that purge air is provided to the first manifold circuit 212. Providing the purge air to a respective one of the first or second manifold circuits 212, 214 prevents exhaust gasses from within the combustion chamber 126 from flowing into an unused manifold circuit 212, 214, e.g., a manifold circuit not providing fuel to the combustion chamber 126.

The components of the manifold pressurization system 20, e.g., the purge inlet 30, the pressure sensor 38, and the control valve 50, may be controlled by the controller 80. The controller 80 may be part of an engine controller of the engine 120 or may be a separate subcontroller of the manifold pressurization system 20. The controller 80 may receive and provide signals to one or more other controllers as will be appreciated by one skilled in the art.

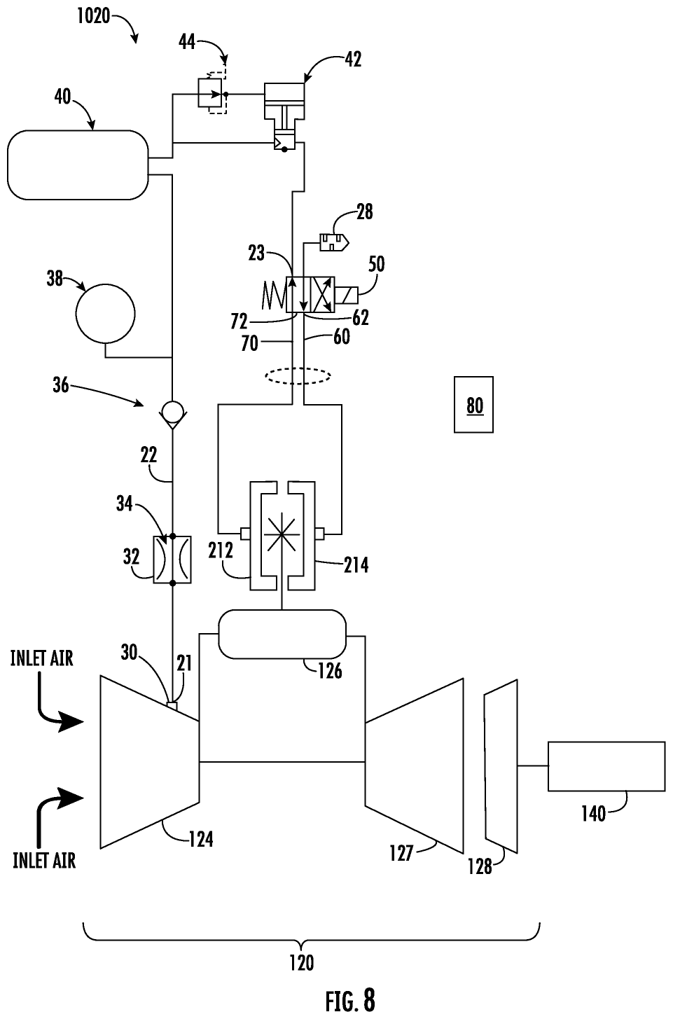

FIG. 8 illustrates another manifold pressurization system 1020 provided in accordance with an embodiment of the present disclosure. The manifold pressurization system 1020 is similar to the manifold pressurization system of FIG. 6 detailed above with like elements including like labels and only the differences detailed below for brevity. The manifold pressurization system 1020 has a common purge line 22 that includes a purge inlet 30, a pneumatic intensifier 42, and a control valve 50.

The pneumatic intensifier 42 receives purge air from the common purge line 22 and increases a pressure of the purge air to a purge pressure before supplying the purge air to the control valve 50. The pneumatic intensifier 42 may receive purge air above atmospheric pressure but below the purge pressure, e.g., a pressure greater than or equal to a pressure of exhaust gasses in the combustion chamber 126. By receiving pressure above atmospheric pressure, the pneumatic intensifier 42 may be smaller and require less power to operate than a pneumatic intensifier receiving air at atmospheric pressure and increasing the received air to purge pressure.

The controller 80 may control the pneumatic intensifier 42 to provide purge air to the control valve 50 at purge pressure. The controller 80 may be in electrical or wireless communication with a pressure sensor 38 to receive a pressure of air within the common purge line 22 upstream of the pneumatic intensifier 42 and may receive a pressure within the combustion chamber, e.g., from a sensor within the combustion chamber 126 or another controller. When the pressure of air within the common purge line 22 is less than the pressure within the combustion chamber 126, the controller 80 controls the pneumatic intensifier 42 to increase a pressure of the purge air to a purge pressure which is equal to or greater than a pressure within the combustion chamber 126.

The manifold pressurization systems detailed herein, e.g., manifold pressurization systems 20, 1020, are configured to pressurize an unused fuel manifold circuits to prevent backflow of exhaust gases and/or fuel therein. The purge pressure may be substantially equal to the pressure within the combustion chamber 126 such that the fuel manifold circuit receiving the purge air is in a hydrostatic state with the combustion chamber 126 to prevent backflow from the combustion chamber 126 into the respective fuel manifold circuit. Preventing backflow may prevent particulates and/or other substances within the exhaust gases from entering and damaging the unused manifold circuits. Preventing backflow may also prevent fuel from the used fuel manifold circuit from entering the unused fuel manifold circuit which may prevent damage to the unused fuel manifold circuit. An additional use of this pneumatic purge is to dispel residual fuels from the turbine manifolds in an attempt to clean these manifold from dirt ingress and combustion bi-products. When the purge pressure is greater than a pressure within the combustion chamber 126, purge air may flow from the unused manifold circuit into the fuel manifolds 210 and/or the combustion chamber 126.

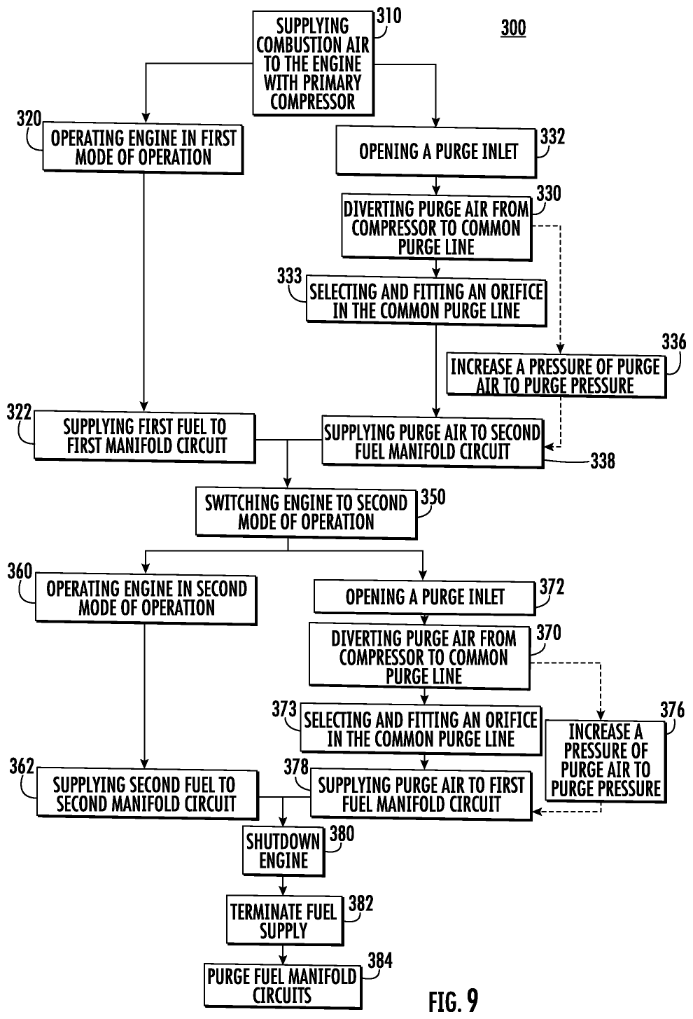

FIG. 9 illustrates a method of operating a dual fuel engine in accordance with an embodiment of the present disclosure and is referred to generally as method 300. The method 300 will be detail with respect to the engine 120, the fuel delivery circuits 200, and the manifold pressurization systems 20, 1020 of FIGS. 1-8. The method 300 is initiated with the functioning of the primary compressor 124, e.g., spinning of the primary compressor 124, such that the primary compressor 124 supplies combustion air to the combustion chamber 126 of the engine 120 (Step 310).

As shown, the method 300 is initiated with the operation of the engine 120 in a first mode of operation (Step 320) such that the engine 120 is operating on a first fuel, e.g., liquid fuel. During the first mode of operation of the engine 120, the method 300 includes supplying the first fuel to the combustion chamber 126 via a first fuel manifold circuit 212 (Step 322). When the engine 120 is operated in the first mode of operation, air is diverted into a common purge line 22 from the primary compressor 124 of the engine 120 (Step 330). Diverting the purge air may include controlling a position of a valve of a purge inlet 30 in response to a pressure within the common purge line 22 (Step 332). The method 300 may include selecting a fixed orifice 34 based on a pressure of the primary compressor 124 (Step 333). The selected fixed orifice 34 may be fitted into the common purge line 22 to limit a volume of air diverted from the primary compressor 124. The fixed orifice may be selected from a plurality of fixed orifices having a size or an opening in a range of 1/64 of an inch to ¼ of an inch. Fitting the fixed orifice 34 may include positioning the fixed orifice 34 in a housing positioned in the common purge line 22. The method may include adjusting a variable orifice 34 to limit a volume of air diverted from the primary compressor 124.

The purge air may pass through a pneumatic intensifier 42 such that the pneumatic intensifier 42 increases a pressure of the purge air within the common purge line 22 to the purge pressure before the purge air is supplied to the control valve 50 (Step 336). A controller 80 of the engine 120 and/or the manifold pressurization system 20, 1020 may receive a signal from a pressure sensor 38 that provides a pressure of the purge air within the common purge line 22 upstream of the pneumatic intensifier 42. The controller 80 may also receive a signal indicative of a pressure within the combustion chamber 126. The controller 80 may provide a signal to the pneumatic intensifier 42 to increase a pressure of the purge air to a desired purge pressure in response to a pressure of the purge air upstream of the pneumatic intensifier 42 and/or a pressure within the combustion chamber 126.

The purge air flows through the common purge line 22 to a control valve 50. The control valve 50 may be positioned in a first position when the engine 120 is in the first mode of operation such that the purge air flows into the second fuel manifold circuit 214 at a purge pressure that is equal to or greater than a pressure within the combustion chamber 126 (Step 338). The purge air fills the second fuel manifold circuit 214 downstream of the distribution block 250 such that exhaust gasses from the combustion chamber 126 are prevented from entering the second fuel manifold circuit 214. When the purge air is at a pressure greater than the exhaust gasses within the combustion chamber 126, purge air may flow from the second fuel manifold circuit 214 into the fuel manifolds 210 and/or the combustion chamber 126.

When the engine 120 is operating in the first mode of operation, the engine 120 may be switched to a second mode of operation (Step 350). The mode of the operation of the engine 120 may be the results of an operating interfacing with a control interface of the mobile power unit 100. In some embodiments, the mode of operation of the engine 120 may result from a signal generated by the mobile power unit 100. For example, the mode of operation of the engine 120 may result from a property of field gas. Specifically, when field gas of sufficient quality is providing, the mobile power unit 100 may send a signal to switch from the first mode of operation to the second mode of operation. Alternatively, when field gas is below a required quality, the mobile power unit 100 may send a signal to switch from the second mode of operation to the first mode of operation. While the switch from the first mode of operation to the second mode of operation of the engine 120 is detailed herein, one skilled in the art would recognize that the method 300 may also include switching the engine 120 from the second mode of operation to the first mode of operation. As detailed herein, the switching of the mode of operation of the engine 120 is considered an on-the-fly fuel switch, as understood by one skilled in the art.

In the second mode of operation of the engine 120 (Step 360), the combustion chamber of the engine 120 is supplied with a second fuel via a second fuel manifold circuit 214 (Step 362). The second fuel may be a gaseous fuel. When the engine 120 is operated in the second mode of operation, air from the primary compressor 124 is diverted into a common purge line 22 from the primary compressor 124 of the engine 120 (Step 370). Diverting the purge air may include controlling a position of a purge inlet 30 in response to a pressure within the common purge line 22 (Step 372). The method 300 may include selecting a fixed orifice 34 based on a pressure of the primary compressor 124 (Step 373).

The purge air may pass through a pneumatic intensifier 42 such that the pneumatic intensifier 42 increases a pressure of the purge air within the common purge line 22 to the purge pressure before the purge air is supplied to the control valve 50 (Step 376). Step 376 is similar to step 336 detailed above and will not be detailed herein for brevity.

The purge air flows through the common purge line 22 to a control valve 50. The control valve 50 may be positioned in a second position when the engine is in the second mode of operation such that the purge air flows into the first fuel manifold circuit 212 at a purge pressure that is equal to or greater than a pressure within the combustion chamber 126 (Step 378). The purge air fills the first fuel manifold circuit 214 downstream of the tee 264 such that exhaust gasses from the combustion chamber 126 are prevented from entering the first fuel manifold circuit 212. When the purge air is at a pressure greater than the exhaust gasses within the combustion chamber 126, purge air may flow from the first fuel manifold circuit 212 into the fuel manifolds 210 and/or the combustion chamber 126.

When the engine 120 is operating in the second mode of operation, the engine 120 may be shutdown (Step 380). Shutting down the engine 120 may include terminating fuel flow into the first and second fuel manifold circuits 212, 214 (Step 382). After the fuel flow is terminated, first and second fuel manifold circuits 212, 214 may be purged with purge air (Step 384). Purging the first and second fuel manifold circuits 212, 214 may include switching the control valve 50 between the first and second positions thereof such that purge air alternates between flowing through the first and second fuel manifold circuits 212, 214. Purging the first and second fuel manifold circuits 212, 214 after fuel flow is terminated may expel residual fuel from the fuel manifold circuits 212, 214.

The manifold pressurization systems detailed herein allow for the manifold pressurization systems to be housed inside an enclosure of the engine 120 which may result in a more compact package for the mobile power unit 100. For example, when the transportation platform 110 is a trailer, the manifold pressurization systems detailed herein may allow for the trailer gooseneck being left with more space for other component sections by eliminating or reducing space required for a pressure intensifier and/or an air storage tank.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

1. A dual fuel gas turbine engine, the engine comprising:
a primary compressor having an inlet opening and an outlet opening;
a combustion chamber in fluid communication with the outlet opening of the primary compressor and positioned to receive compressed air from the outlet opening of the primary compressor, the combustion chamber having a first fuel manifold and a second fuel manifold, the combustion chamber having a first mode of operation in which the first fuel manifold is configured to provide fuel to the combustion chamber and the second fuel manifold is unused, the combustion chamber having a second mode of operation in which the second fuel manifold circuit is configured to provide fuel to the combustion chamber and the first fuel manifold circuit is unused; and
a manifold pressurization system comprising:
a purge inlet in fluid communication with the primary compressor adjacent the outlet opening;
a common purge line connected at an upstream end to the purge inlet, the common purge line configured to provide purge air at a purge pressure equal to or greater than a combustion pressure within the combustion chamber;
a first purge line connected at a downstream end thereof to the first fuel manifold circuit; and
a control valve connected to a downstream end of the common purge line and an upstream end of the first purge line, the control valve having a second position in which the control valve connects the common purge line with the first purge line to supply purge air to the first fuel manifold circuit, the control valve being in the second position when the combustion chamber is in the second mode of operation.

2. The engine of claim 1, wherein the manifold pressurization system further comprises:
a second purge line connected at a downstream end thereof to the second fuel manifold circuit,
wherein the control valve is connected to an upstream end of the second purge line, the control valve having a first position in which the control valve connects the common purge line with the second purge line to supply purge air to the second fuel manifold circuit, and
wherein the control valve is in the first position when the combustion chamber is in the first mode of operation.

3. The engine of claim 1, wherein the common purge line comprises a purge air reservoir to provide purge air when the primary compressor is not operating.

4. The engine of claim 1, wherein the common purge line includes an orifice, the orifice configured to limit a volume of the purge air removed from the primary compressor.

5. The engine of claim 4, wherein the orifice is a fixed orifice.

6. The engine of claim 1, wherein the common purge line includes a check valve, the check valve configured to prevent backflow within the common purge line.

7. The engine of claim 2, wherein the control valve has a third position in which control valve closes the downstream end of the common purge line, the upstream end of the first purge line, and the upstream end of the second purge line, the control valve being in the third position during a shutdown mode of operation of the combustion chamber.

8. The engine of claim 1, wherein the primary compressor is a multistage compressor having a P3 point, the purge inlet positioned at the P3 point of the primary compressor.

9. The engine of claim 1, wherein the purge inlet has a closed position in which the purge air is prevented from entering the common purge line and an open position in which the purge air is allowed to enter the common purge line.

10. The engine of claim 9, wherein the common purge line includes a pressure sensor configured to provide a signal indicative of a pressure of the common purge line to a control system of the dual fuel gas turbine engine.

11. The engine of claim 10, further comprising the control system configured to receive the signal from the pressure sensor and control a position of the purge inlet in response to the signal from the pressure sensor, the position of the purge inlet controlling a pressure within the common purge line.

12. The engine of claim 1, wherein the first fuel manifold circuit is configured to provide the first fuel which is a liquid fuel into the combustion chamber and the second fuel manifold circuit is configured to provide the second fuel which is a gaseous fuel into the combustion chamber.

13. A hydraulic fracturing pumping system, the system comprising:
a dual fuel gas turbine engine, the dual fuel gas turbine engine comprising:
a primary compressor having an inlet opening and an outlet opening:
a combustion chamber in fluid communication with the outlet opening of the primary compressor and positioned to receive compressed air from the outlet opening of the primary compressor, the combustion chamber having a first fuel manifold and a second fuel manifold, the combustion chamber having a first mode of operation in which the first fuel manifold is configured to provide fuel to the combustion chamber and the second fuel manifold is unused, the combustion chamber having a second mode of operation in which the second fuel manifold circuit is configured to provide fuel to the combustion chamber and the first fuel manifold circuit is unused; and
a manifold pressurization system comprising:
a purge inlet in fluid communication with the primary compressor adjacent the outlet opening;
a common purge line connected at an upstream end to the purge inlet, the common purge line configured to provide purge air at a purge pressure equal to or greater than a combustion pressure within the combustion chamber;
a control valve connected to a downstream end of the common purge line; and
a purge air reservoir located along the common purge line between the control valve and the purge inlet;
a hydraulic fracturing pump connected to the dual fuel gas turbine engine such that the hydraulic fracturing pump is driven by the dual fuel gas turbine engine; and
a trailer in which the dual fuel gas turbine engine and hydraulic fracturing pump are mounted thereon.

14. The system of claim 13, wherein the manifold pressurization system further comprises:
a first purge line connected at a downstream end thereof to the first fuel manifold circuit,
wherein the control valve has a second position in which the control valve connects the common purge line with the first purge line to supply purge air to the first fuel manifold circuit, and
wherein the control valve being in the second position when the combustion chamber is in the second mode of operation.

15. The system of claim 14, wherein the manifold pressurization system further comprises:
a second purge line connected at a downstream end thereof to the second fuel manifold circuit,
wherein the control valve is connected to an upstream end of the second purge line, the control valve having a first position in which the control valve connects the common purge line with the second purge line to supply purge air to the second fuel manifold circuit, and
wherein the control valve is in the first position when the combustion chamber is in the first mode of operation.

16. The system of claim 13, wherein the purge inlet has a closed position in which the purge air is prevented from entering the common purge line and an open position in which the purge air is allowed to enter the common purge line, wherein the common purge line includes a pressure sensor configured to provide a signal indicative of a pressure of the common purge line to a control system of the dual fuel gas turbine engine, further comprising the control system configured to receive the signal from the pressure sensor and control a position of the purge inlet in response to the signal from the pressure sensor, the position of the purge inlet controlling a pressure within the common purge line.

17. The system of claim 13, wherein the first fuel manifold circuit is configured to provide the first fuel which is a liquid fuel into the combustion chamber and the second fuel manifold circuit is configured to provide the second fuel which is a gaseous fuel into the combustion chamber.

18. An electric power generation system, the system comprising:
a dual fuel gas turbine engine, the dual fuel gas turbine engine comprising:
a primary compressor having an inlet opening and an outlet opening;
a combustion chamber in fluid communication with the outlet opening of the primary compressor and positioned to receive compressed air from the outlet opening of the primary compressor, the combustion chamber having a first fuel manifold and a second fuel manifold, the combustion chamber having a first mode of operation in which the first fuel manifold is configured to provide fuel to the combustion chamber and the second fuel manifold is unused, the combustion chamber having a second mode of operation in which the second fuel manifold circuit is configured to provide fuel to the combustion chamber and the first fuel manifold circuit is unused; and
a manifold pressurization system comprising:
a purge inlet in fluid communication with the primary compressor adjacent the outlet opening;
a common purge line connected at an upstream end to the purge inlet, the common purge line configured to provide purge air at a purge pressure equal to or greater than a combustion pressure within the combustion chamber;
a control valve connected to a downstream end of the common purge line; and
a purge air reservoir located along the common purge line between the control valve and the purge inlet;
an electric generator connected to the dual fuel gas turbine engine such that the electric generator is driven by the dual fuel gas turbine engine; and
a trailer in which the dual fuel gas turbine engine and electric generator are mounted thereon.

19. The system of claim 18, wherein the manifold pressurization system further comprises:
a first purge line connected at a downstream end thereof to the first fuel manifold circuit,
wherein the control valve has a second position in which the control valve connects the common purge line with the first purge line to supply purge air to the first fuel manifold circuit, and
wherein the control valve being in the second position when the combustion chamber is in the second mode of operation.

20. The system of claim 19, wherein the manifold pressurization system further comprises:
a second purge line connected at a downstream end thereof to the second fuel manifold circuit,
wherein the control valve is connected to an upstream end of the second purge line, the control valve having a first position in which the control valve connects the common purge line with the second purge line to supply purge air to the second fuel manifold circuit, and
wherein the control valve is in the first position when the combustion chamber is in the first mode of operation.
